(19) United States
(12) Patent Application Publication
(10) Pub. No.: US 2012/0026080 A1
(43) Pub. Date: Feb. 2, 2012

(54) ELECTRONIC DEVICE AND UNLOCKING METHOD THEREOF

(75) Inventors: PO-TAI HUANG, Tu-Cheng (TW); CHAO-YUN YU, Tu-Cheng (TW); MING-WEI KAO, Tu-Cheng (TW); CHIA-YUAN CHANG, Tu-Cheng (TW); FA-HSIANG CHANG, Tu-Cheng (TW)

(73) Assignee: CHI MEI COMMUNICATION SYSTEMS, INC., Tu-Cheng City (TW)

(21) Appl. No.: 12/869,770

(22) Filed: Aug. 27, 2010

(30) Foreign Application Priority Data
Jul. 29, 2010 (TW) 99125060

(51) Int. Cl. G09G 5/00

(52) U.S. Cl. 345/156

(57) ABSTRACT

An electronic device and a method enables an unlock operation of the electronic device. When the electronic device in a lock state is moved for the unlock operation, the electronic device receives a three-axis acceleration vector of the electronic device from an accelerometer. The electronic device analyzes three movement directions of the electronic device along three coordinate axes. The electronic device determines whether the analyzed three movement directions are the same as three predetermined movement directions along the three coordinate axes. If the analyzed three movement directions are the same as the three predetermined movement directions along the three coordinate axes, the electronic device is changed from the lock state to an unlock state.

### BACKGROUND

1. Technical Field

Embodiments of the present disclosure relate to an electronic device operation, and more particularly to an electronic device and an unlocking method for the electronic device.

2. Description of Related Art

Unlocking an electronic device for use may require entry of alphanumeric passcode on a physical keypad or a virtual keypad on a touch screen of the electronic device. However, recall of such various alphanumeric pass codes may be difficult to remember sometimes.

### BRIEF DESCRIPTION OF THE DRAWINGS

FIG. 1 is a block diagram of one embodiment of an electronic device comprising an unlocking system.

FIG. 2 is a block diagram of the unlocking system of FIG. 1.

FIG. 3 is a schematic diagram of the electronic device of FIG. 1 located along three coordinate axes.

FIG. 4 shows exemplary movement of the electronic device of FIG. 1.

FIG. 5 shows a schematic diagram of three component vectors of the movement along the three coordinate axes of the electronic device of FIG. 4.

FIG. 6 is a flowchart illustrating one embodiment of a method of unlocking a electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

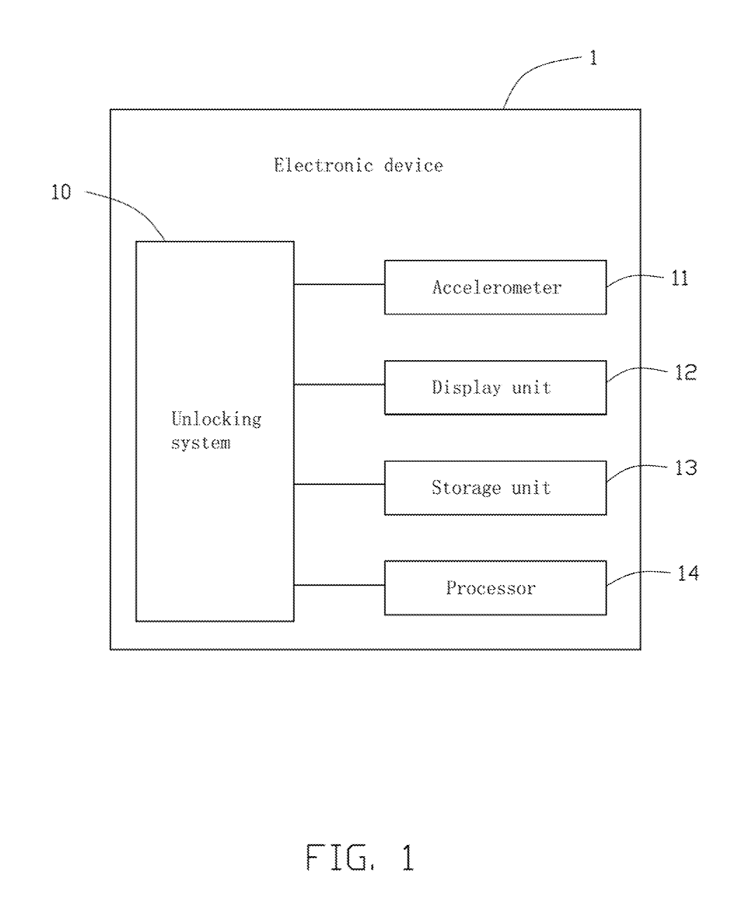

FIG. 1 is a block diagram of one embodiment of an electronic device 1 comprising an unlocking system 10. The electronic device 1 further comprises an accelerometer 11, a display unit 12, a storage unit 13 and at least one processor 14. When the electronic device 1 is in a lock state, the display unit 12 is turned off and a plurality of hard keys of the electronic device 1 are disabled. Otherwise, when the electronic device 1 is in an unlock state, the display unit 12 is turned on and the electronic device 1 can be operated by the plurality of hard keys of the electronic device 1. The electronic device 1 in the lock state can be changed to an unlock state by moving the electronic device 1 in a predetermined movement of unlocking. For example, the electronic device 1 is preset the predetermined movement of unlocking. If a detected movement of the electronic device 1 by the accelerometer 11 is same to the predetermined movement, the electronic device 1 in the lock state can be changed to the unlock state and the display unit 12 is turned on and the plurality of hard keys of the electronic device 1 are enabled. Depending on the embodiment, the electronic device 1 may be a mobile phone or personal digital assistants (PDAs), for example.

The electronic device 1 is generally controlled and coordinated by operating system software, such as UNIX, Linux, Windows 95, 98, NT, 2000, XP, Vista, Mac OS X, an embedded operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

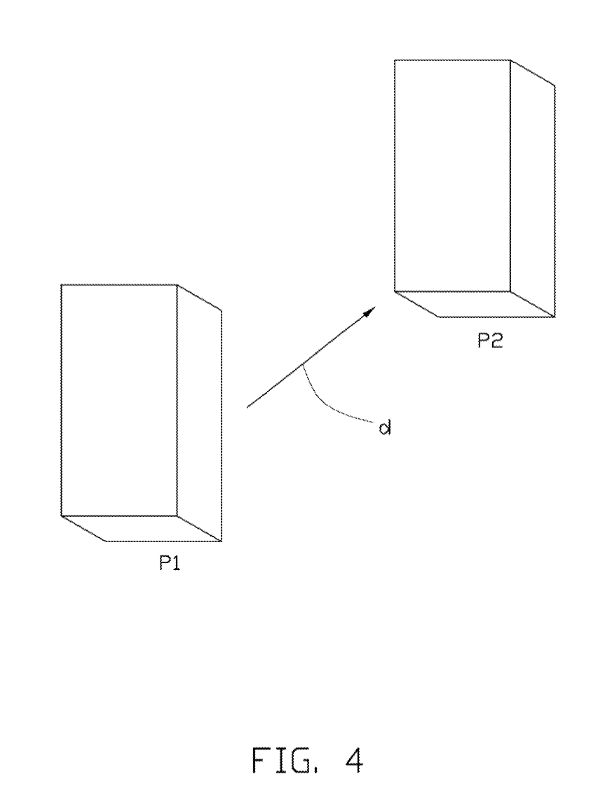

The accelerometer 11 is operable to detect movement of the electronic device 1 and discern magnitude and direction of the movement as a vector quantity to generate a three-axis acceleration vector. For example, as shown in FIG. 4, as the electronic device 1 moves from the first position P1 to the second position P2 in a direction P1P2, the accelerometer 11 detects the movement of electronic device 1 and generates a three-axis acceleration vector d.

The display unit 12 is operable to display information of the electronic device 1. In one embodiment, the display unit 12 can display direction information of the electronic device 1, such as a direction along the three coordinate axes. In other embodiments, the display unit 12 can also display a notification message indicating the unlock state of the electronic device. In addition, the display unit 12 can be a display screen, a resistive touch screen or a capacitive touch screen. Furthermore, if the electronic device 1 is in a lock state, the display unit 12 can be turned off.

The storage unit 13 is electronically connected to the unlocking system 10, the accelerometer 11, the display unit 12 and the processor 14. The storage unit 13 is operable to store many kinds of data, such as module codes, computerized codes of the unlocking system 10, programs of an operating system, other applications of the electronic device 1 and the movement information of the electronic device 1, such as a detected three-axis acceleration vector of the electronic device 1 from the accelerometer 11. The storage unit 13 may include a hard disk drive, flash memory, RAM, ROM, cache, or external storage mediums.

The processor 14 is operable to execute one or more computerized codes of the unlocking system 10 and the electronic device 1. The one or more computerized codes of the unlocking system 10 and the electronic device 1 may be stored in the storage unit 13 and executed by the processor 14. The processor 14, as an example, may include a CPU, math coprocessor, or shift register.

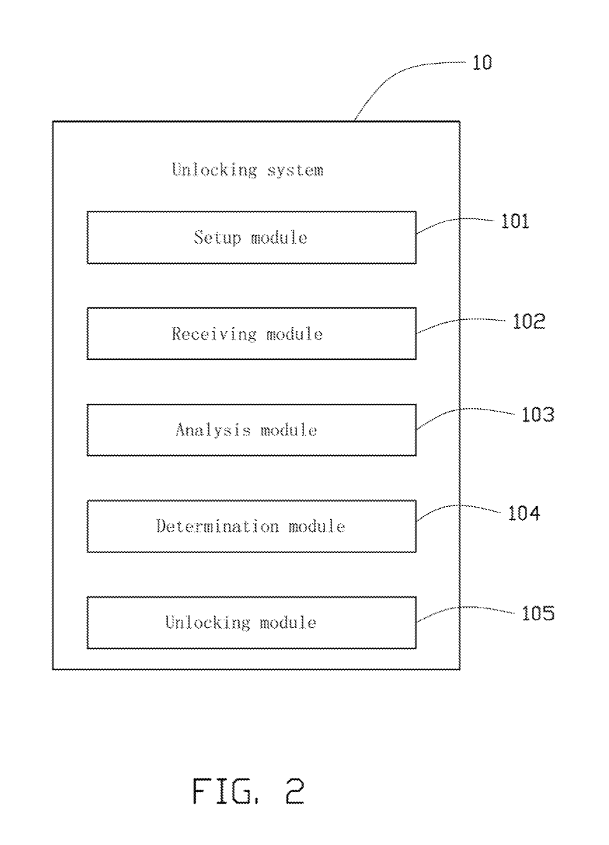

FIG. 2 is a block diagram of the unlocking system 10. The unlocking system 10 includes a setup module 101, a receiving module 102, an analysis module 103, a determination module 104 and an unlocking module 105.

The receiving module 102 is operable to receive the three-axis acceleration vector of the electronic device 1 from the accelerometer 11 for transmission to the analysis module 103. As shown in FIG. 4, the accelerometer 11 detects a movement of the electronic device 1 and generates the three-axis acceleration vector d. The receiving module 102 receives the three-axis acceleration vector d of the electronic device 1 from the accelerometer 11.

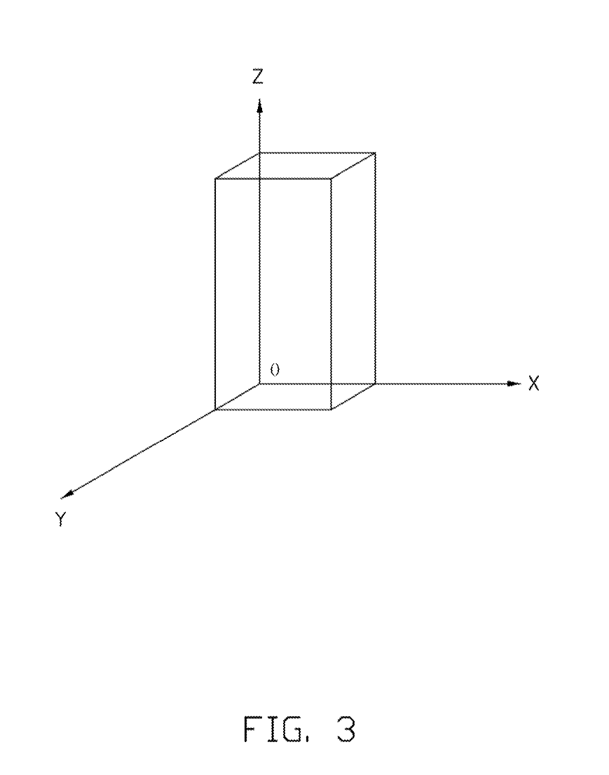

The analysis module 103 is operable to analyze three movement directions of the electronic device 1 along the three coordinate axes. In one embodiment, as shown in FIG. 3, the electronic device 1 is located in a space of the three coordinate axes. The analysis module 103 separates the received three-axis acceleration vector from the receiving module 102 into three component vectors along the three coordinate axes. The analysis module 103 continually analyzes three directions of the three component vectors.

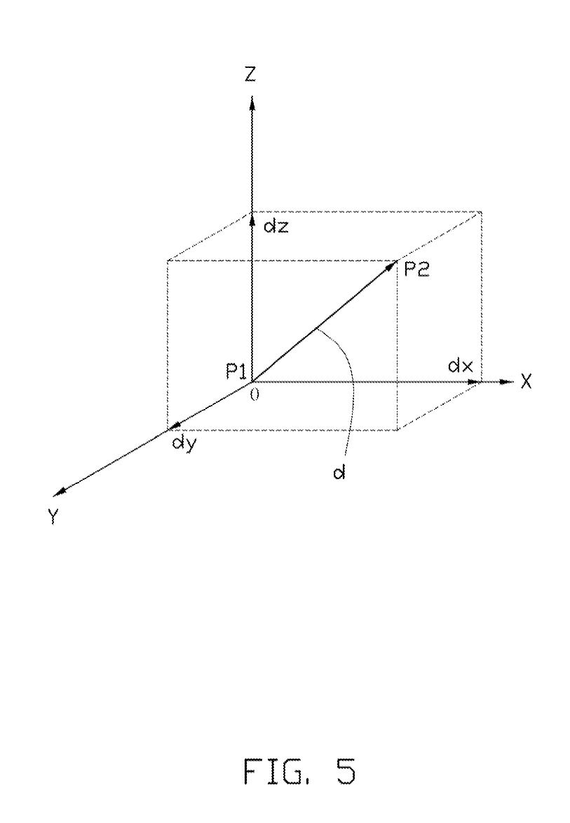

As shown in FIG. 4, the electronic device 1 moves from the position P1 to the position P2 and the accelerometer 11 generates a three-axis acceleration vector d. As shown in FIG. 5 is a schematic diagram analyzed by the analysis module 103 illustrating three component vectors along the three coordinate axes of a electronic device 1 of FIG. 4. The analysis module 103 separates the three-axis acceleration vector d into three component vectors dx, dy, dz along the three coordinate axes X, Y, and Z axis. Finally, the analysis module 103 analyzes three movement directions of the three component vectors dx, dy, dz. For example, if the three component vectors dx, dy, dz are all plus values, the analysis module 103 analyzes the three movement directions of the electronic device 1 along the three coordinate axes are positive direction to the zero point of the three coordinate axes.

Accordingly, the setup module 101 is operable to set predetermined movement directions of the electronic device 1 along the three coordinate axes such as for an unlocking operation. In one embodiment, the electronic device 1 is moved in one direction to set the unlocking operation, and accelerometer 11 detects the movement and generates a three-axis acceleration vector. The analysis module 103 separates the three-axis acceleration vector into three component vectors along the three coordinate axes. The analysis module 103 analyzes the three directions of the three component vectors along the three coordinate axes and the setup module 101 sets the analyzed three directions as the three predetermined movement directions for unlocking the electronic device 1. The setup module 101 then saves the analyzed three direction three predetermined movement directions in the storage unit 13.

The determination module 104 is operable to determine whether the analyzed three movement directions of the electronic device 1 are the same as the three predetermined movement directions along the three coordinate axes for unlocking the electronic device 1. If the analyzed three movement directions of the electronic device 1 are the same as the three predetermined movement directions along the three coordinate axe, the determination module 104 initiates the unlocking module 105. In one embodiment, the determination module 104 determines whether each movement direction of vectors of the electronic device 1 is the same as each predetermined direction of the three vectors for unlocking the electronic device 1.

The unlocking module 105 is operable to unlock the electronic device 1. In one embodiment, the unlocking module 105 unlocks the electronic device 1 from the lock state by turning on the display unit 12. In other embodiments, the unlocking module 105 unlocks a locked keypad or keyboard of the electronic device 1.

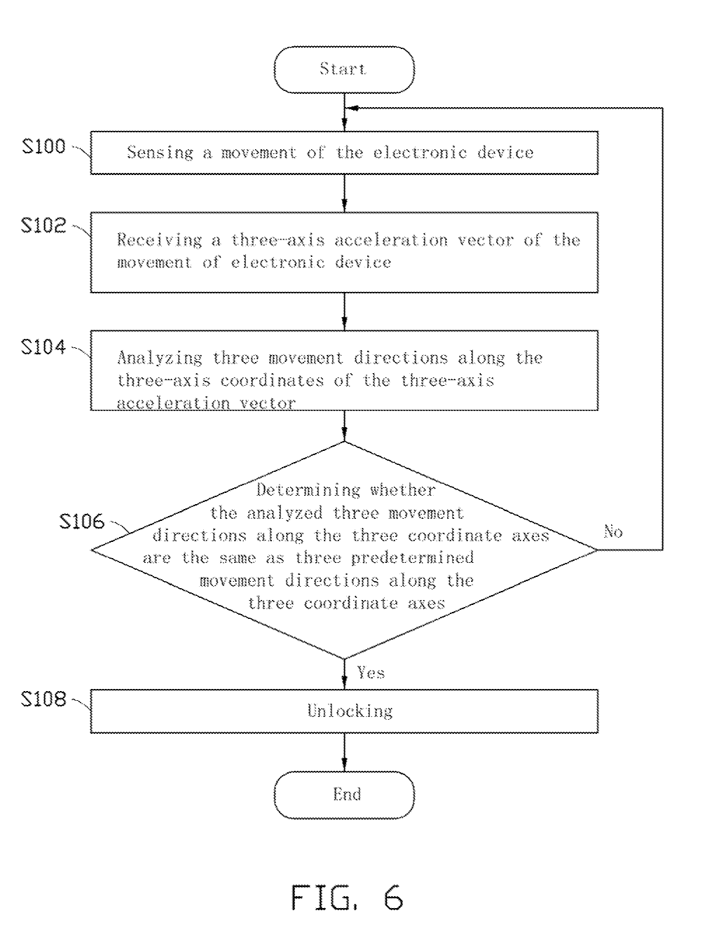

FIG. 6 is a flowchart illustrating one embodiment of a method of unlocking a electronic device 1. Depending on the embodiment, additional blocks may be added, others deleted, and the ordering of the blocks may be changed.

In block S90, the setup module 101 sets three directions along the three coordinate axes for unlocking the electronic device 1. In one embodiment, the electronic device 1 is moved in one direction to set the unlocking operation, and the accelerometer 11 detects the movement of the electronic device 1 and generates a three-axis acceleration vector. The setup module 101 sends the generated three-axis acceleration vector in the storage unit 13.

In block S100, the accelerometer 11 detects a movement of the electronic device 1 and generates a three-axis acceleration vector.

In block S102, the receiving module 102 receives the three-axis acceleration vector of the electronic device 1 from the accelerometer 11.

In block S104, the analysis module 103 analyzes the three movement directions of the electronic device along the three coordinate axes.

In block S106, the determination module 104 determines whether the analyzed three movement directions along the three coordinate axes are the same as three predetermined movement directions along the three coordinate axes for unlocking the electronic device 1. If the analyzed three directions are the same as the predetermined three directions, block S108 is implemented. If the analyzed three directions are not the same as the predetermined three directions, block S100 is repeated. For example, the determination module 104 determines whether each analyzed three movement direction is the same as each predetermined movement direction along the x coordinate axe, the y coordinate and the z coordinate in sequence.

In block S108, the unlocking module 105 unlocks the electronic device 1 from the lock state. In one embodiment, the unlocking module 105 unlocks the electronic device 1 from the lock state by turning on the display unit 12 and outputting a message to the display unit 12. In other embodiments, the unlocking module 105 unlocks a locked keypad or keyboard of the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising an accelerometer, a display unit, a storage unit and a processor, the electronic device further comprising:
a receiving module to receive a three-axis acceleration vector of the electronic device from the accelerometer;
an analysis module to analyze three movement directions of the electronic device along three coordinate axes according to the three-axis acceleration vector;
a determination module to determine whether the analyzed three movement directions are the same as three predetermined movement directions along the three coordinate axes; and
an unlocking module to unlock the electronic device from a lock state upon determining that the analyzed three movement directions are the same as the three predetermined movement directions.

2. The electronic device of claim 1, further comprising a setup module to set the three predetermined movement directions of the electronic device along the three coordinate axes to unlock the electronic device.

3. The electronic device of claim 2, wherein the setup module saves the three predetermined movement directions of the electronic device along the three coordinate axes in the storage unit.

4. The electronic device of claim 1, wherein the display unit outputs a message when the electronic device is unlocked.

5. The electronic device of claim 1, wherein the unlocking module unlocks the electronic device from the lock state by unlocking the display unit of the electronic device.

6. A method for unlocking an electronic device, the electronic device comprising an accelerometer, a display unit, a storage unit and a processor, the method comprising:
moving the electronic device;
receiving a three-axis acceleration vector of the electronic device from the accelerometer;
analyzing three movement directions of the electronic device along three coordinate axes;
determining whether the analyzed three movement directions are the same as three predetermined movement directions along the three coordinate axes; and
unlocking the electronic device from a lock state upon detection that the analyzed three movement directions are the same as the three predetermined movement directions.

7. The method of claim 6, further comprising:
setting the three predetermined movement directions of the electronic device along the three coordinate axes for unlocking the electronic device.

8. The method of claim 7, wherein setting the three predetermined movement directions comprises:
moving the electronic device in one direction;
receiving a three-axis acceleration vector of the electronic device by the accelerometer; and
saving the three-axis acceleration vector in the storage unit.

9. The method of claim 6, further comprising:
outputting a message to the display unit when the electronic device is unlocked.

10. The method of claim 6, wherein unlocking the electronic device is implemented by unlocking the display unit of the electronic device.

11. A storage medium having stored thereon instructions that, when executed by a processor, causes the processor to perform a method of unlocking an electronic device, the electronic device comprising an accelerometer, a display unit, a storage unit and a processor, the method comprising:
moving the electronic device;
receiving a three-axis acceleration vector of the electronic device from the accelerometer;
analyzing three movement directions of the electronic device along three coordinate axes;
determining whether the analyzed three movement directions are the same as three predetermined movement directions along the three coordinate axes; and
unlocking the electronic device from a lock state upon detection that the analyzed three movement directions are the same as the three predetermined movement directions.

12. The storage medium of claim 11, the method further comprising:
setting the three predetermined movement directions of the electronic device along the three coordinate axes for unlocking the electronic device.

13. The storage medium of claim 12, wherein setting the three predetermined movement directions comprises:
moving the electronic device in one direction;
receiving a three-axis acceleration vector of the electronic device by the accelerometer; and
saving the three-axis acceleration vector in the storage unit.

14. The storage medium of claim 11, the method further comprising:
outputting a message to the display unit when the electronic device is unlocked.

15. The storage medium of claim 11, wherein unlocking the electronic device is implemented by unlocking the display unit of the electronic device.
